(19) United States
(12) Patent Application Publication
(10) Pub. No.: US 2022/0033667 A1
(43) Pub. Date: Feb. 3, 2022

(54) Treatment Liquid Composition For Ink Jet Pigment Printing, Ink Set, And Recording Method

(71) Applicant: Seiko Epson Corporation, Tokyo (JP)

(72) Inventors: Akiko YAMADA, Shiojiri (JP); Hideki OKADA, Shiojiri (JP)

(21) Appl. No.: 17/389,699

(22) Filed: Jul. 30, 2021

(30) Foreign Application Priority Data
Jul. 31, 2020 (JP) 2020-130108

(51) Int. Cl. C09D 11/322; D06P 5/30; D06P 5/20

(52) U.S. Cl. CPC C09D 11/322; D06P 5/2066; D06P 5/30

(57) ABSTRACT

A treatment liquid composition for ink jet pigment printing is a treatment liquid composition which is used to be adhered to a cloth and which includes resin particles containing a polyester-based resin and a cationic compound.

The present application is based on, and claims priority from JP Application Serial Number 2020-130108, filed Jul. 31, 2020, the disclosure of which is hereby incorporated by reference herein in its entirety.

### BACKGROUND

### 1. Technical Field

The present disclosure relates to a treatment liquid composition for ink jet pigment printing, an ink set, and a recording method.

### 2. Related Art

An ink jet recording method is able to record a highly fine image by a relatively simple apparatus and has been rapidly developed in various fields. In particular, various investigations have been carried out to more stably obtain a recorded matter having a higher quality.

For example, JP-A-2012-251062 has disclosed a method for coloring fibers using a pigment by an ink jet method, the fiber coloring method capable of forming a high quality colored cloth (texture, fastness, and the like) without causing a workability problem. In this ink jet method, an ink for ink jet pigment printing which is to be cross-linked and fixed to fibers by heating is used. The ink for ink jet pigment printing is formed such that in an ink composition formed of a pigment dispersion (A) which contains a pigment, a water-soluble pigment dispersant, and a hydrophilic solvent and which has an average particle diameter of 200 nm or less and a maximum particle diameter of 500 nm or less, a water-soluble fixing agent (B), and a cross-linking agent (C), the water-soluble pigment dispersant of (A) is a dispersant obtained by neutralizing by a basic material, an emulsion polymer having a molecular weight of 2,000 to 20,000 which is formed from 20 to 80 parts of a predetermined (meth)acrylate ester monomer, 80 to 20 parts of an aliphatic vinyl monomer (2) having a carboxyl group, and 0 to 20 parts of an aliphatic vinyl monomer (3) having a non-carboxyl group-based cross-linking functional group; the water-soluble fixing agent (B) is an agent having a cross-linking functional group; and the cross-linking agent (C) is an agent formed from a material having a functional group which performs a cross-linking reaction at a temperature of 100° C. or more, with the cross-linking functional group of the water-soluble pigment dispersant Of (A) and the cross-linking functional group of the water-soluble fixing agent (B).

However, by using an ink jet pigment printing ink as disclosed in JP-A-2012-251062, when pigment printing is performed on a recording medium including a cloth by ink jet recording, a recorded matter obtained thereby is still required to be improved in terms of a rubbing fastness and a washing resistance.

### SUMMARY

Through intensive research carried out to solve the above problem, the present inventors found that by using a treatment liquid composition for ink jet pigment printing which is used to be adhered to a cloth and which includes resin particles containing a polyester-based resin and a cationic compound, a recorded matter excellent in fastness can be obtained, and as a result, the present disclosure was completed.

That is, according to an aspect of the present disclosure, there is provided a treatment liquid composition for ink jet pigment printing which is used to be adhered to a cloth and which includes resin particles containing a polyester-based resin and a cationic compound.

According to another aspect of the present disclosure, there is provided an ink set which includes the treatment liquid composition for ink jet pigment printing according to the aspect of the present disclosure and an ink composition containing a pigment.

According to another aspect of the present disclosure, there is provided a recording method including a step of adhering to a cloth, the treatment liquid composition for ink jet pigment printing according to the aspect of the present disclosure.

### BRIEF DESCRIPTION OF THE DRAWINGS

FIG. 1s a flowchart showing one example of a recording method of this embodiment.

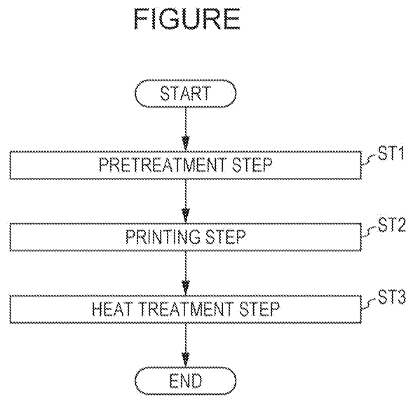

### DESCRIPTION OF EXEMPLARY EMBODIMENTS

Hereinafter, if needed, with reference to the drawing, although an embodiment (hereinafter, referred to as “this embodiment”) of the present disclosure will be described in detail, the present disclosure is not limited thereto and may be variously changed and/or modified without departing from the scope of the present disclosure. In addition, in this specification, a “(meth)acrylic-based resin” indicates both an acrylic-based resin and a methacrylic-based resin corresponding thereto.

In this specification, “pigment printing” indicates recording (printing) of an ink composition containing a pigment on a recording medium including a cloth and may also be called simply “printing” or “recording” in some cases. In addition, “ink jet pigment printing” indicates recording (printing) of an ink composition containing a pigment on a recording medium including a cloth by an ink jet method and is one type of ink jet recording. A “recorded matter” indicates a matter in which an image is formed by recording an ink composition on a recording medium including a cloth.

### Treatment Liquid Composition

A treatment liquid composition of this embodiment is used to be adhered to a cloth and contains resin particles containing a polyester-based resin and a cationic compound. In addition, although being used for ink jet pigment printing, the treatment liquid composition of this embodiment may be a liquid composition which is used to be adhered to the same cloth as that to which an ink composition containing a pigment is adhered and may also be a liquid composition to be adhered to a cloth by a method other than an ink jet method, that is, for example, by a coating method using a roll coater or the like which will be described later. In addition, although being able to be adhered to a cloth before, after, or during the ink composition is adhered thereto, the treatment liquid composition of this embodiment is preferably adhered to a cloth before the ink composition is adhered thereto.

The reason a recorded matter excellent in fastness can be obtained by using the treatment liquid composition of this embodiment is believed as described below. However, the reason is not limited to that described below. That is, when a related treatment liquid composition is applied to a cloth in advance, a pigment printing ink stays in the vicinity of a surface of the cloth, and hence, the fastness (such as rubbing fastness and/or washing resistance) of a recorded matter is still required to be improved. In addition, in order to improve the fastness of a recorded matter, when an ink composition containing a cross-linking agent is used as disclosed in JP-A-2012-251062, in the case in which printing is performed on a predetermined cloth, such as a polyester cloth, formed from hydrophobic fibers, the cloth has no functional groups to react with the cross-linking agent, and hence, an effect to improve the fastness of the recorded matter is not significant. In addition, in order to advance a cross-linking reaction, the cross-linking agent is required to be processed by a heat treatment in many cases, and hence, when a high-temperature heat treatment cannot be performed, the fastness is also still required to be improved. On the other hand, since the treatment liquid composition of this embodiment contains resin particles containing a polyester-based resin, when a coating film is formed on a cloth, the polyester-based resin improves an adhesion to fibers of the cloth and is not likely to be peeled away from surfaces of the fibers, and as a result, a recorded matter excellent in fastness can be obtained. In addition, the polyester-based resin is estimated because of its structure and characteristics to have a high affinity to a cloth as compared to that of another resin, such as an acrylic-based resin or an urethane-based resin. In addition, since the treatment liquid composition of this embodiment is used, a recorded matter excellent in storage stability, color development, and texture can also be obtained.

### Resin Particles

The treatment liquid composition of this embodiment contains resin particles containing a polyester-based resin. The resin particles are particles containing a resin and may also be called a “resin dispersion” or a “resin emulsion”.

The resin particles of this embodiment may be self-dispersible resin particles into which a hydrophilic component necessary for stable dispersion in water is introduced or resin particles having a water dispersible property by using an external emulsifier. However, in order not to disturb a reaction with a polyvalent metal compound to be contained in a recording medium, the resin particles are preferably a self-emulsifying type resin dispersion.

Although the polyester-based resin is not particularly limited, for example, there may be mentioned a polyester resin obtained by a condensation reaction between a carboxylic acid, such as succinic acid, adipic acid, sebacic acid, dimer acid, maleic anhydride, phthalic anhydride, isophthalic acid, terephthalic acid, trimellitic acid, or pyromellitic acid; and a polyvalent alcohol including at least one of a diol, such as ethylene glycol, diethylene glycol, triethylene glycol, polypropylene glycol, dipropylene glycol, tripropylene glycol, 1,2-propanediol, 1,3-propanediol, 1,2-butanediol, 1,3-butanediol, 1,4-butanediol, 2,3-butanediol, 2-methyl-1,2-propanediol, 1,5-pentanediol, 2-methyl-2,3-butanediol, 1,6-hexanediol, 1,2-hexanediol, 2,5-hexanediol, 2-methyl-2,4-pentanediol, 2,3-dimethyl-2,3-butanediol, 2-ethyl-hexanediol, 1,2-octanediol, 1,2-decanediol, 2,2,4-trimethylpentanediol, 2-butyl-2-ethyl-1,3-propanediol, or 2,2-diethyl-1,3-propanediol, and a triol, such as glycerin or trimethylolpropane, and a tetraol, such as diglycerin, ditrimethylolpropane, or pentaerythritol. The polyester-based resin may be used alone, or at least two types thereof may be used in combination.

Although not particularly limited, in order to obtain a recorded matter more excellent in storage stability, the polyester-based resin preferably has no aggregating property to a cationic compound which will be described later. The aggregating property to the cationic compound can be confirmed whether the resin is allowed or not allowed to react with the cationic compound, and in particular, the aggregating property can be confirmed by the method which will be described in an example.

Although not particularly limited, a glass transition temperature (hereinafter, simply referred to as “Tg” in some cases) of the polyester-based resin is preferably 20° C. or more, more preferably 30° C. to 70° C., and further preferably 40° C. to 70° C. Since the glass transition temperature of the polyester-based resin is in the range described above, a recorded matter more excellent in fastness and texture tends to be obtained. The glass transition temperature can be obtained by a known measurement method. For example, by using a differential scanning calorimeter “DSC7000” manufactured by Hitachi Hi-Tech Science Corporation, the glass transition temperature can be measured in accordance with JIS K7121 (plastic transition temperature measurement method).

Although not particularly limited, a weight average molecular weight (hereinafter, simply referred to as “Mw” in some cases) of the polyester-based resin is preferably 5,000 to 30,000, more preferably 7,000 to 25,000, and further preferably 10,000 to 20,000. Since the weight average molecular weight of the polyester-based resin is in the range described above, a recorded matter more excellent in fastness and texture tends to be obtained. The weight average molecular weight can be obtained by a known measurement method such as a gel permeation chromatography which uses a polystyrene as a reference substance.

The resin particles of this embodiment may further contain at least one resin other than the polyester-based resin. As the resin other than the polyester-based resin, for example, there may be mentioned an urethane-based resin, a polycarbonate-based resin, a (meth)acrylic-based resin, a styrene-based resin, a silicone-based resin, a styrene-acrylic-based resin, a fluorene-based resin, a polyolefin-based resin, a rosin modified resin, a terpene-based resin, a polyamide-based resin, an epoxy-based resin, a vinyl chloride-based resin, a vinyl chloride-vinyl acetate-based copolymer, or an ethylene-vinyl acetate-based resin.

A content of the resin particles in terms of a solid content of the polyester-based resin with respect to the total mass of the treatment liquid composition is preferably 0.1 percent by mass or more, more preferably 0.5 to 10 percent by mass, and further preferably 1.0 to 5.0 percent by mass. Since the content of the resin particles is in the range described above, a recorded matter more excellent in texture and fastness tends to be obtained.

A content of the resin particles in terms of a solid content of all the resin particles with respect to the total mass of the treatment liquid composition is preferably 0.1 percent by mass or more, more preferably 0.5 to 10 percent by mass, and further preferably 1.0 to 5.0 percent by mass. Since the content of the resin particles is in the range described above, a recorded matter more excellent in texture and fastness tends to be obtained.

### Cationic Compound

The treatment liquid composition contains a cationic compound. The cationic compound may be any one of a polyvalent metal salt, a cationic polymer, and a cationic surfactant, and in order to obtain a recorded matter more excellent in fastness, a cationic polymer is preferably contained. Since the treatment liquid composition contains a cationic polymer, compared to the case in which a polyvalent metal salt is only contained, an appropriate amount of an ink can be maintained at a cloth surface layer, and a recorded matter more excellent in fastness is estimated to be obtained. The cationic compound may be used alone, or at least two types thereof may be used in combination.

In order to effectively and surely obtain the effect of the present disclosure, for example, there may be preferably used a polyethyleneimine; a polyallylamine resin, such as a polydiallylamine or a polyallylamine; an alkylamine polymer; or a polymer having one of a primary to a tertiary amino group or a quaternary ammonium base disclosed in one of JP-A-59-20696, JP-A-59-33176, JP-A-59-33177, JP-A-59-155088, JP-A-60-11389, JP-A-60-49990, JP-A-60-83882, JP-A-60-109894, JP-A-62-198493, JP-A-63-49478, JP-A-63-115780, JP-A-63-280681, JP-A-1-40371, JP-A-6-234268, JP-A-7-125411, and JP-A-10-193776. From the same point as described above, a weight average molecular weight of each of those cationic polymers is preferably 5,000 or more and more preferably 5,000 to approximately 100,000. The weight average molecular weight of the cationic polymer can be measured by a gel permeation chromatography using a polystyrene as a reference substance. The cationic polymer may be used alone, or at least two types thereof may be used in combination.

Among the cationic polymers, an amine-based resin is preferable in terms of excellent image quality. As the amine-based resin, for example, a cationic polyallylamine resin, polyamine resin, or polyamide resin may be mentioned. The polyallylamine resin, the polyamine resin, and the polyamide resin are resins having a polyallylamine structure, a polyamine structure, and a polyamide structure, respectively, in their main skeletons. The cationic resin may be water soluble or water insoluble in the form of resin particles and is preferably water soluble. The cationic resin particles are used as a flocculant.

Although the polyvalent metal salt is not particularly limited, in order to effectively and surely obtain the effect of the present disclosure, a polyvalent metal salt of an inorganic acid or a polyvalent metal salt of an organic acid is preferable. Although the polyvalent metal salt as described above is not particularly limited, for example, there may be mentioned a salt of an alkaline earth metal (such as magnesium or calcium) of Group II of the periodic table, a transition metal (such as lanthanum) of Group III of the periodic table, an earth metal (such as aluminum) of Group XIII of the periodic table, or a lanthanoid (such as neodymium). In addition, as the salt of the polyvalent metal mentioned above, for example, a carboxylate salt (such as a formate, an acetate, or a benzoate), a sulfate, a nitrate, a chloride, or a thiocyanate is preferable. In particular, as the polyvalent metal salt, at least one selected from the group consisting of a calcium salt or a magnesium salt of a carboxylic acid (such as formic acid, acetic acid, or benzoic acid), a calcium salt or a magnesium salt of sulfuric acid, a calcium salt or a magnesium salt of nitric acid, calcium chloride or magnesium chloride, and a calcium salt or a magnesium salt of thiocyanic acid is preferable. The polyvalent metal salt may be used alone, or at least two types thereof may be used in combination.

Although the organic acid is not particularly limited, a carboxylic acid is preferable, and for example, maleic acid, acetic acid, oxalic acid, malonic acid, succinic acid, or citric acid may be mentioned. Among those mentioned above, a monovalent or a divalent carboxylic acid is preferable. Since the carboxylic acid as described above is contained, aggregation effects of a polymer and a wax are further improved, and as a result, the color development tends to be further improved. The organic acid may be used alone, or at least two types thereof may be used in combination.

A content of the cationic compound in terms of a solid content with respect to the total mass of the treatment liquid composition is preferably 0.1 percent by mass or more, more preferably 0.5 to 10 percent by mass, and further preferably 1.0 to 5.0 percent by mass. Since the content of the cationic compound is in the range described above, a recorded matter more excellent in fastness tends to be obtained.

### Surfactant

In view of glossiness, the treatment liquid composition preferably further contains a surfactant. Although the surfactant is not particularly limited, for example, there may be mentioned an acetylene glycol-based surfactant, a fluorine-based surfactant, or a silicone-based surfactant. The surfactant may be used alone, or at least two types thereof may be used in combination.

Although the acetylene glycol-based surfactant is not particularly limited, at least one selected from 2,4,7,9-tetramethyl-5-decyne-4,7-diol, an alkylene oxide adduct thereof, 2,4-dimethyl-5-decyne-4-ol, or an alkylene oxide adduct thereof is preferable. Although a commercially available product of the acetylene glycol-based surfactant is not particularly limited, for example, there may be mentioned Olfine 104 Series or E Series, such as Olfine E1010 (trade name, manufactured by Air Products Japan, Inc.); or Surfynol 104, 465, 485, 61, or DF110D (trade name, manufactured by Nisshin Chemical Industry Co., Ltd.). The acetylene glycol-based surfactant may be used alone, or at least two types thereof may be used in combination.

Although the fluorine-based surfactant is not particularly limited, for example, there may be mentioned a perfluoroalkyl sulfonate, a perfluoroalkyl carboxylate, a perfluoroalkyl phosphate, a perfluoroalkyl ethylene oxide adduct, a perfluoroalkyl betaine, or a perfluoroalkyl amine oxide compound. Although a commercially available product of the fluorine-based surfactant is not particularly limited, for example, there may be mentioned S-144 or S-145 (trade name, manufactured by Asahi Glass Co., Ltd.); FC-170C, FC-430, or Fluorad FC4430 (trade name, manufactured by Sumitomo 3M Limited); FSO, FSO-100, FSN, FSN-100, or FS-300 (trade name, manufactured by Du Pont); or FT-250 or 251 (trade name, manufactured by Neos Co., Ltd.). The fluorine-based surfactant may be used alone, or at least two types thereof may be used in combination.

Although the silicone-based surfactant is not particularly limited, for example, a polysiloxane-based compound or a polyether modified organosiloxane may be mentioned. Although a commercially available product of the silicone-based surfactant is not particularly limited, for example, there may be mentioned SAG 503A (trade name, manufactured by Nisshin Chemical Industry Co., Ltd.); BYK-028, BYK-306, BYK-307, BYK-333, BYK-341, BYK-345, BYK-346, BYK-347, BYK-348, or BYK-349 (trade name, manufactured by BYK); or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.). The silicone-based surfactant may be used alone, or at least two types thereof may be used in combination.

A hydrophilic-lipophilic balance (HLB) value of the surfactant is preferably 10 or more, more preferably 13 or more, and further preferably 15 or more. In addition, the HLB value of the surfactant is preferably 20 or less. Since the HLB value of the surfactant is in the range described above, an excessive permeation of the treatment liquid composition and an ink into a cloth is suppressed, and a recorded matter more excellent in texture tends to be obtained. The HLB value of the surfactant may be obtained by a known method, such as Griffin's method.

A surface tension of the surfactant is preferably 40 mN/m or more, more preferably 45 mN/m or more, and further preferably 50 to 100 mN/m. Since the surface tension of the surfactant is in the range described above, an excessive permeation of the treatment liquid composition and an ink into a cloth is suppressed, and a recorded matter more excellent in texture tends to be obtained. The surface tension of the surfactant may be measured at 25° C. by Wilhelmy method, for example, using a 0.1%-aqueous solution. As a measurement device, for example, a surface tension meter “CBVP-Z” manufactured by Kyowa Interface Science Co., Ltd. which has been generally used may be used.

A content of the surfactant with respect to the total mass of the treatment liquid composition is preferably 0.01 to 3.0 percent by mass, more preferably 0.05 to 2.0 percent by mass, and further preferably 0.1 to 1.0 percent by mass. Since the content of the surfactant is in the range described above, a recorded matter more excellent in texture tends to be obtained.

### Water

The treatment liquid composition may contain water. As the water of this embodiment, for example, purified water, such as ion-exchanged water, ultrafiltration water, reverse osmosis water, or distilled water, may be mentioned, or water, such as ultrapure water, from which ionic impurities are removed as much as possible may also be mentioned. In addition, when water sterilized, for example, by ultraviolet ray irradiation or addition of hydrogen peroxide is used, in the case in which a condensate liquid is stored for a long period of time, generation of fungi and/or bacteria can be prevented. Hence, the storage stability of the treatment liquid composition tends to be further improved.

The treatment liquid composition may also contain a glue agent. As the glue agent, for example, there may be mentioned a starch material such as corn or wheat; a cellulose-based material, such as a carboxymethyl cellulose or a hydroxymethyl cellulose; a polysaccharide, such as sodium alginate, gum arabic, locust bean gum, gum tragacanth, guar gum, or tamarind seeds; a protein, such as gelatin or casein; a natural water-soluble high molecular weight material, such as tannin or lignin; or a synthetic water-soluble high molecular weight material, such as a poly(vinyl alcohol)-based compound, a poly(ethylene oxide)-based compound, an acrylic acid-based compound, or a maleic anhydride-based compound.

The treatment liquid composition may also contain components, such as a lubricant, a reduction inhibitor, an antiseptic agent/fungicide, such as Proxel XL2 (trade name, manufactured by Arch Chemicals), an anti-mold agent, a softener, a chelating agent (such as sodium ethylenediaminetetraacetic acid) trapping metal ions which influence dispersion, a pH adjuster such as triethanolamine, a solubilizer, a viscosity adjuster, an antioxidant, and/or a corrosion inhibitor, which are generally used for a treatment liquid composition for printing.

### Ink Set

An ink set of this embodiment includes the treatment liquid composition of this embodiment and at least one ink composition for ink jet pigment printing. The ink composition of this embodiment contains a pigment and is an ink to be used for recording (printing) on a recording medium including a cloth by an ink jet method.

The ink composition of this embodiment is able to appropriately contain resin particles, a surfactant, water, and the like, which are the components also contained in the treatment liquid composition described above, and the description of the above components may also be applied to the description of the components of the ink composition.

### Pigment

The ink composition of this embodiment contains a pigment. In addition, the treatment liquid composition may also contain a pigment. The pigment may be contained in the composition as particles containing a pigment. Although the pigment is not particularly limited, for example, the following may be mentioned. The pigment may be used alone, or at least two types thereof may be used in combination.

The ink compositions may be discriminated as a cyan ink, a magenta ink, a yellow ink, a black ink, a white ink, and the like.

Although a pigment used for the cyan ink is not particularly limited, for example, there may be mentioned C.I. Pigment Blue 1, 2, 3, 15, 15:1, 15:2, 15:3, 15:34, 15:4, 16, 18, 22, 25, 60, 65, or 66, C.I. Vat Blue 4 or 60, or C.I. Direct Blue 199.

Although a pigment used for the magenta ink is not particularly limited, for example, there may be mentioned C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:2, 48:5, 57:1, 88, 112, 114, 122, 123, 144, 146, 149, 150, 166, 168, 170, 171, 175, 176, 177, 178, 179, 184, 185, 187, 202, 209, 219, 224, or 245, or C.I. Pigment Violet 19, 23, 32, 33, 36, 38, 43, or 50.

Although a pigment used for the black ink is not particularly limited, a carbon black may be mentioned. Although a concrete trade name of the carbon black is not particularly limited, for example, there may be mentioned Bonjetblack CW-1 (manufactured by Orient Chemical Industries Co., Ltd.); No. 2300, No. 900, MCF88, No. 33, No. 40, No. 45, No. 52, MA7, MA8, MA100, No. 2200B, or the like (manufactured by Mitsubishi Chemical Corporation); Raven 5750, Raven 5250, Raven 5000, Raven 3500, Raven 1255, Raven 700, or the like (manufactured by Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, or the like (manufactured by CABOT JAPAN K.K.); Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, or Special Black 4 (manufactured by Degussa).

Although a pigment used for the yellow ink is not particularly limited, for example, there may be mentioned EMACOL SF Yellow J701F (trade name, manufactured by Sanyo Color Works, Ltd.); or C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, or 180.

Although a pigment used for the white ink is not particularly limited, for example, there may be mentioned C.I. Pigment Yellow 6, 18, or 21, titanium oxide, zinc oxide, zinc sulfide, antimony oxide, zirconium oxide, white hollow resin particles, or white high molecular weight particles.

Although a pigment other than those mentioned above is not particularly limited, for example, there may be mentioned C.I. Pigment Green 7 or 10; C.I. Pigment Brown 3, 5, 25, or 26; or C.I. Pigment Orange 1, 2, 5, 7, 13, 14, 15, 16, 24, 34, 36, 38, 40, 43, or 63.

A content of the pigment in terms of a solid content with respect to the total mass of the ink composition is preferably 2.0 percent by mass or more, more preferably 2.0 to 10 percent by mass, and further preferably 2.0 to 5.0 percent by mass. Since the content of the pigment is in the range described above, a recorded matter more excellent in color development tends to be obtained.

### Organic Solvent

The ink composition of this embodiment preferably contains an organic solvent. The treatment liquid composition of this embodiment may also contain an organic solvent. The organic solvent is not particularly limited as long as being usable together with water. The organic solvent may be used alone, or at least two types thereof may be used in combination.

Although the type of organic solvent is not particularly limited, for example, there may be mentioned a cyclic nitrogen-containing compound, an aprotic polar solvent, a monoalcohol, an alkylpolyol, or a glycol ether.

Although the aprotic polar solvent is not particularly limited, for example, a cyclic ketone compound, a chain ketone compound, or a chain nitrogen-containing compound may be mentioned. In addition, as the cyclic nitrogen-containing compound and the aprotic polar solvent, for example, a pyrrolidone, an imidazolidinone, a sulfoxide, a lactone, an amide ether, or an imidazole may be mentioned as a representative solvent example. Although the pyrrolidone is not particularly limited as long as having a pyrrolidone skeleton, for example, 2-pyrrolidone, an N-alkyl-2-pyrrolidone, or a 1-alkyl-2-pyrrolidone may be mentioned. As the imidazolidinone, for example, 1,3-dimethyl-2-imidazolidinone may be mentioned; as the sulfoxide, for example, dimethylsulfoxide may be mentioned; as the lactone, for example, γ-butyrolactone may be mentioned; and as the imidazole, for example, imidazole, 1-methylimidazole, 2-methylimidazole, or 1,2-dimethylimidazole may be mentioned.

Although the monoalcohol is not particularly limited, for example, there may be mentioned methanol, ethanol, n-propyl alcohol, iso-propyl alcohol, n-butanol, 2-butanol, tert-butanol, iso-butanol, n-pentanol, 2-pentanol, 3-pentanol, or tert-pentanol.

Although the alkyl polyol is not particularly limited, for example, there may be mentioned glycerin, ethylene glycol, diethylene glycol, triethylene glycol, propylene glycol (1,2-propanediol), dipropylene glycol, trimethylolpropane, 1,3-propylene glycol (1,3-propanediol), isobutylene glycol (2-methyl-1,2-propanediol), 1,2-butanediol, 1,3-butanediol, 1,4-butanediol, 2-butene-1,4-diol, 1,2-pentanediol, 1,5-pentanediol, 2-methyl-2,4-pentanediol, 1,2-hexanediol, 1,6-hexanediol, 2-ethyl-1,3-hexanediol, 1,7-heptanediol, or 1,8-octanediol. In order to obtain an excellent storage stability, among those mentioned above, the organic solvent in the composition preferably includes any one of 1,3-propanediol, 1,4-butanediol, and 1,5-pentanediol and also preferably includes trimethylolpropane.

As the organic solvent, a water-soluble organic solvent is preferable. The “water-soluble” indicates the condition in which after water and an organic solvent are mixed and stirred at a mass ratio of 1:1 at ordinary temperature, no separation therebetween is observed, or no cloudy state is confirmed.

Although the glycol ether is not particularly limited, for example, a glycol diether or a glycol monoether may be mentioned.

A content of the organic solvent with respect to the total mass of the ink composition or the treatment liquid composition is preferably 0.1 to 50 percent by mass, more preferably 0.5 to 35 percent by mass, and further preferably 1.0 to 20 percent by mass. Since the content of the organic solvent is in the range described above, a drying property of the composition which is adhered to a recording medium tends to be further improved, and a recorded matter more excellent in fastness tends to be obtained.

The ink composition of this embodiment preferably contains resin particles. As the resin particles contained in the ink composition of this embodiment may be the same as or different from those contained in the treatment liquid composition described above. Resin particles different from the resin particles contained in the treatment liquid composition described above are also preferably used.

The resin particles of the ink composition may be self-dispersible resin particles into which a hydrophilic component necessary for stable dispersion in water is introduced or resin particles having a water dispersible property by using an external emulsifier. However, in order not to disturb a reaction with a polyvalent metal compound to be contained in a recording medium, the resin particles are preferably a self-emulsifying type resin dispersion.

As a resin, for example, there may be mentioned an urethane-based resin, a polycarbonate-based resin, a (meth)acrylic-based resin, a styrene-based resin, a silicone-based resin, a styrene-acrylic-based resin, a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate-based copolymer, or an ethylene-vinyl acetate-based resin. Those resins may be used alone, or at least two types thereof may be used in combination. Among those resins mentioned above, for the resin particles, an urethane-based resin, a polycarbonate-based resin, a (meth)acrylic-based resin, or a styrene-based resin is preferable, and an urethane-based resin or a (meth)acrylic-based resin is more preferable, and as the urethane-based resin, a polycarbonate-based urethane resin is more preferable. Since the resins mentioned above are used, the rubbing fastness can be improved.

The urethane-based resin is a resin having an urethane bond in its molecule. In view of the storage stability of the ink, the urethane-based resin is preferably an anionic urethane-based resin having an anionic functional group, such as a carboxy group, a sulfo group, or a hydroxy group.

As the urethane-based resin, there may be mentioned a polyether type urethane-based resin, a polyester type urethane-based resin, or a polycarbonate type urethane-based resin, which has besides an urethane bond, a polyether bond, a polyester bond, or a polycarbonate bond, respectively, in its main chain. At least two of those urethane-based resins may be used in combination.

As a commercially available product of the urethane-based resin, for example, there may be mentioned ETERNACOLL UW-1501F or UW-5002 (trade name, manufactured by Ube Industries, Ltd.), Takelac WS-5000, W-6061, W-6110, WS-5984, or WS-5100 (trade name, manufactured by Mitsui Chemicals Inc.), Permarine UA-150, UA-200, or U-Coat UX-390 (trade name, manufactured by Sanyo Chemical Industries, Ltd.), or Hydran WLS-210 (trade name, manufactured by DIC Corporation).

The polycarbonate-based resin is a resin having a polycarbonate bond in its molecule. When no urethane-based resin is used, the polycarbonate-based resin is preferably used instead.

As a commercially available product of the (meth)acrylic-based resin, Movinyl 966A or 6760 (trade name, manufactured by Japan Coating Resin Corporation) may be mentioned.

The (meth)acrylic-based resin indicates a resin having a (meth)acrylic skeleton. Although the (meth)acrylic-based resin is not particularly limited, for example, there may be mentioned a polymer of a (meth)acrylic-based monomer, such as (meth)acrylic acid or a (meth)acrylate ester, or a copolymer of a (meth)acrylic-based monomer and another monomer. As the another monomer, for example, a vinyl-based monomer, such as styrene, may be mentioned. In addition, in this specification, “(meth)acryl” is a concept including both “methacryl” and “acryl”.

As a commercially available product of the silicone-based resin, for example, there may be mentioned POLON-MF014, POLON-MF-18T, POLON-MF-33, or KM-2002-T (trade name, Shin-Etsu Chemical Co., Ltd.), or WACKER FINISH WR1100, NP2406, POWERSOFT FE 55, or TS2406 (trade name, manufactured by Asahi Kasei Corporation).

Although not particularly limited, an acid value of the resin contained in the resin particles is preferably 1 to 300 KOHmg/g, more preferably 10 to 200 KOHmg/g, and further preferably 20 to 100 KOHmg/g.

A content of the resin particles of the ink composition in terms of a solid content with respect to the total mass of the composition is preferably 1.0 percent by mass or more, more preferably 2.0 to 20 percent by mass, and further preferably 3.0 to 17 percent by mass. Since the content of the resin particles is in the range described above, a recorded matter excellent in texture and rubbing fastness tends to be obtained.

A recording method of this embodiment includes a step of adhering the treatment liquid composition described above to a cloth. Hereinafter, steps of the recording method of this embodiment each will be described with reference to an example including a step (pretreatment step) in which the treatment liquid composition is adhered before the ink composition is adhered (FIGURE).

### Pretreatment Step (ST1)

The recording method of this embodiment includes a pretreatment step of adhering the treatment liquid composition to a cloth. As a method to adhere the treatment liquid composition to a cloth, for example, a method in which a cloth is dipped in the treatment liquid composition, a method in which the treatment liquid composition is applied by a roll coater or the like, or a method (such as an ink jet method or a spray method) in which the treatment liquid composition is jetted may be mentioned, and any one of the above methods may be used.

The recording method of this embodiment may include, after the step of adhering the treatment liquid composition to a cloth, a drying step of drying the treatment liquid composition applied to the cloth. Although the treatment liquid composition may be spontaneously dried, in order to increase a drying rate, the drying is preferably performed with heating. When the drying step of drying the treatment liquid composition is performed with heating, although a heating method is not particularly limited, for example, a heat press method, a normal pressure steaming method, a high pressure streaming method, or a thermofix method may be mentioned. In addition, although a heat source of the heating is not particularly limited, for example, an infrared ray (lamp) may be mentioned.

Although a material forming a cloth to be used in the recording method of this embodiment is not particularly limited, for example, natural fibers, such as cotton, hemp, wool, or silk; synthetic fibers, such as a polypropylene, a polyester, a nylon, an acetate, a triacetate, a polyamide, or a polyurethane; or biodegradable fibers such as a polylactic acid may be mentioned, and in addition, blended fibers among those mentioned above may also be mentioned. As the cloth, for example, a fabric, a knitted fabric, or a non-woven cloth formed from the fibers mentioned above may be used. In view of fastness, among the materials forming the above clothes, fibers (hydrophobic fibers) having a hydrophobic property are preferable, and a polyester or a nylon is more preferable. In addition, in view of dyeing property, a cloth containing fibers (cotton, hemp, rayon, or the like) primarily formed from a cellulose is also preferably used. In particular, when the material forming the cloth is a polyester, the polyester-based resin contained in the treatment liquid composition of this embodiment has a higher affinity to the cloth, and when a coating film is formed on the cloth, the polyester-based resin improves the adhesion to the fibers of the cloth, and the coating film is not easily peeled away from fiber surfaces, so that a recorded matter more excellent in fastness can be obtained. On the other hand, when the material forming the cloth is a polyester, since the affinity thereof to the treatment liquid composition of this embodiment is high, the treatment liquid composition may easily permeate in the cloth, and as a result, the texture is liable to be degraded in some cases. However, since the treatment liquid composition of this embodiment contains a surfactant, an excessive permeation of the treatment liquid composition into the cloth is suppressed, and hence, a recorded matter more excellent in texture tends to be obtained.

### Printing Step (ST2)

The recording method of this embodiment includes a printing step of printing the ink composition described above to the cloth. In particular, ink droplets ejected by an ink jet recording method are adhered to the cloth to form an image thereon. As the ink jet recording method, for example, any one of a charge deflection method, a continuous method, and an on-demand method (a piezoelectric type or a bubble jet (registered trademark) type) may be mentioned. Among those ink jet recording methods, a method using a piezoelectric type ink jet recording device is particularly preferable.

### Heat Treatment Step (ST3)

The recording method of this embodiment may also include a heat treatment step of performing a heat treatment on the cloth to which the ink composition described above is printed. By the heat treatment step, the pigment is preferably dyed on the fibers. The heat treatment step may be performed using a related known method, and for example, an HT method (high temperature steaming method), an HP method (high pressure steaming method), or a thermosol method may be mentioned. However, for a polyester or a nylon, the heat treatment step is preferably performed at a low temperature.

In consideration of the reduction in damage on the cloth and the curing of the resin in the ink composition, a temperature in the heat treatment step is preferably 80° C. to 200° C. and more preferably 100° C. to 180° C.

### EXAMPLES

Hereinafter, although the present disclosure will be described in more detail with reference to examples, the present disclosure is not limited thereto. Hereinafter, unless otherwise particularly noted, “part(s)” and “%” are each on a mass basis.

### Materials of Treatment Liquid Composition and Ink Composition

In the following examples and comparative examples, main materials used for the treatment liquid composition and the ink composition are as described below.

### Resin Particles

Polyester-based resin 1 (“Z-1100”, manufactured by Goo Chemical Co., Ltd., Mw: 15,000, Tg: 50° C., with no aggregating property)

Polyester-based resin 2 (“Vylonal MD-2000”, manufactured by Toyobo Co., Ltd., Mw: 18,000, Tg: 67° C., with aggregating property)

Urethane-based resin 1 (“Superflex 650”, manufactured by DKS Co., Ltd., with no aggregating property)

Urethane-based resin 2 (“Takelac WS-6021”, manufactured by Mitsui Chemicals Inc., solid content: 30%)

Acrylic-based resin (“SD-10”, manufactured by Toagosei Company, Limited, with no aggregating property) CATIONIC COMPOUND

Cationic polymer 1 (“PAA-SA”, manufactured by Nittobo Medical Co., Ltd., polyallylamine resin)

Cationic polymer 2 (“EP-1137”, manufactured by Takamatsu Oil & Fat Co., Ltd.)

Calcium chloride

Magnesium chloride

### Surfactant

Surfynol 485 (trade name, manufactured by Nisshin Chemical Industry Co., Ltd., acetylene glycol-based surfactant, HLB value: 17, surface tension: 51 mN/m (catalog value measured using 0.1% aqueous solution)

Olfine E1010 (trade name, manufactured by Nisshin Chemical Industry Co., Ltd., acetylene glycol-based surfactant, HLB value: 13 to 14, surface tension: 40 mN/m (catalog value measured using 0.1% aqueous solution)

BYK-028 (trade name, manufactured by BYK Japan KK, silicone-based surfactant)

BYK-348 (trade name, manufactured by BYK Japan KK, silicone-based surfactant)

### Antiseptic Agent/Fungicide

Proxel XL2 (trade name, manufactured by Arch Chemicals)

### Water

Ion-exchanged water

### Pigment

Cyan pigment (C.I. Pigment Blue 15: 3)

### Organic Solvent

Glycerin

1,2-hexanediol

### Presence or Absence of Aggregating Property

The aggregating property of the resin particles to the cationic compound was confirmed as described below. In a glass bottle having a volume of 30 cc, 15 cc of an aqueous solution of the cationic compound at a concentration of 2% was charged. Subsequently, droplets of a dispersion of the resin particles were dripped using a dropper to the aqueous solution of the cationic compound described above and were observed. In the case in which after being solidified and separated from the aqueous solution, the droplets described above floated on the liquid surface or sank to the bottom of the glass bottle, the resin particles were judged to have an aggregating property. On the other hand, in the case in which even after being brought into contact with the aqueous solution, the droplets described above were not solidified, were not clearly separated from the aqueous solution, and were entirely dissolved or cloudily diffused, the resin particles were judged to have no aggregating property.

In the case described above, as the cationic compound, an aqueous solution of the cationic polymer 1 at a concentration of 2 percent by mass, an aqueous solution of the cationic polymer 2 at a concentration of 2 percent by mass, an aqueous solution of calcium chloride at a concentration of 2 percent by mass, and an aqueous solution of magnesium chloride at a concentration of 2 percent by mass were used. That is, “to have an aggregating property” indicates that the resin particles were evaluated to have an aggregating property to all the cationic compounds, and “to have no aggregating property” indicates that the resin particles were evaluated to have no aggregating property to all the cationic compounds.

### Preparation of Treatment Liquid Composition and Ink Composition

Components were mixed and sufficiently stirred to form the compositions shown in Tables 1 are 2, so that treatment liquid compositions and ink compositions were obtained. In addition, in the following Tables 1 and 2, the units of the numerical values of the components other than the organic solvent and the water are each percent by mass of a solid content, the unit of the numerical value of the organic solvent is percent by mass, and the water is contained so that the total of the composition is 100.0 percent by mass. In addition, the pigment dispersion liquid shown in Table 2 was prepared such that after 65 parts by mass of a pigment was mixed with 35 parts by mass of Joncryl 611 (trade name, manufactured by BASF Japan Ltd.) which was a styrene acrylic-based dispersion resin not shown in the table, 1.70 parts by mass of potassium hydroxide, and 250 parts by mass of ultrapure water purified by an ion-exchange method and a reverse osmosis method and was then dispersed for 10 hours by a ball mill using zirconia beads, coarse and large particles were removed by filtration using glass-fiber filter paper GA-100 (trade name, manufactured by Advantec Toyo Kaisha, Ltd.), and the composition was prepared so as to have a pigment concentration of 10 percent by mass.

TABLE 1

| | | TREATMENT | TREATMENT | TREATMENT | TREATMENT | TREATMENT | TREATMENT |
|---|---|---|---|---|---|---|---|
| | | LIQUID | LIQUID | LIQUID | LIQUID | LIQUID | LIQUID |
| | | COMPOSI- | COMPOSI- | COMPOSI- | COMPOSI- | COMPOSI- | COMPOSI- |
| | | TION 1 | TION 2 | TION 3 | TION 4 | TION 5 | TION 6 |
| RESIN | POLYESTER-BASED | 2 | — | 1 | 3 | 2 | 2 |
| PARTICLES | RESIN 1 | | | | | | |
| | POLYESTER-BASED | — | 2 | — | — | — | — |
| | RESIN 2 | | | | | | |
| | URETHANE-BASED | — | — | — | — | — | — |
| | RESIN 1 | | | | | | |
| | ACRYLIC-BASED RESIN | — | — | — | — | — | — |
| CATIONIC | CATIONIC POLYMER 1 | 2 | 2 | 2 | 2 | 2 | 2 |
| COMPOUND | CATIONIC POLYMER 2 | — | — | — | — | — | — |
| | CALCIUM CHLORIDE | — | — | — | — | — | — |
| | MAGNESIUM CHLORIDE | — | — | — | — | — | — |
| SURFACTANT | SURFYNOL 485 | — | — | — | — | 1 | — |
| | OLFINE E1010 | — | — | — | — | — | 1 |
| | BYK-028 | 0.01 | 0.01 | 0.01 | 0.01 | 0.01 | 0.01 |
| | PROXEL XL2 | 0.2 | 0.2 | 0.2 | 0.2 | 0.2 | 0.2 |
| | PURIFIED WATER | BALANCE | BALANCE | BALANCE | BALANCE | BALANCE | BALANCE |
| | | TREATMENT | TREATMENT | TREATMENT | TREATMENT | TREATMENT | TREATMENT |
| | | LIQUID | LIQUID | LIQUID | LIQUID | LIQUID | LIQUID |
| | | COMPOSI- | COMPOSI- | COMPOSI- | COMPOSI- | COMPOSI- | COMPOSI- |
| | | TION 7 | TION 8 | TION 9 | TION 10 | TION 11 | TION 12 |
| RESIN | POLYESTER-BASED | 2 | 2 | 2 | — | — | — |
| PARTICLES | RESIN 1 | | | | | | |
| | POLYESTER-BASED | — | — | — | — | — | — |
| | RESIN 2 | | | | | | |
| | URETHANE-BASED | — | — | — | — | 2 | — |
| | RESIN 1 | | | | | | |
| | ACRYLIC-BASED RESIN | — | — | — | — | — | 2 |
| CATIONIC | CATIONIC POLYMER 1 | — | — | — | 2 | 2 | 2 |
| COMPOUND | CATIONIC POLYMER 2 | 2 | — | — | — | — | — |
| | CALCIUM CHLORIDE | — | 1 | — | — | — | — |
| | MAGNESIUM CHLORIDE | — | — | 1 | — | — | — |
| SURFACTANT | SURFYNOL 485 | — | — | — | — | — | — |
| | OLFINE E1010 | — | — | — | — | — | — |
| | BYK-028 | 0.01 | 0.01 | 0.01 | 0.01 | 0.01 | 0.01 |
| | PROXEL XL2 | 0.2 | 0.2 | 0.2 | 0.2 | 0.2 | 0.2 |
| | PURIFIED WATER | BALANCE | BALANCE | BALANCE | BALANCE | BALANCE | BALANCE |

TABLE 2

| | INK COMPOSITION |
|---|---|
| CYAN PIGMENT DISPERSION LIQUID | 30.0 |
| (SOLID CONTENT: 10%) | |
| URETHANE-BASED RESIN 2 | 16.7 |
| GLYCERIN | 13.0 |
| 1,2-HEXANEDIOL | 1.0 |
| BYK-348 | 0.3 |
| PROXEL XL2 | 0.2 |
| PURIFIED WATER | BALANCE |

### Storage Stability

After 20 ml of the treatment liquid composition was charged in a 30-mL sample bottle and then left for 5 minutes and 24 hours, the presence or absence of precipitates and/or aggregates were observed by visual inspection, and the storage stability was evaluated by the following evaluation criteria.

### Evaluation Criteria

A: No precipitates/aggregates are observed after 24 hours.

B: No precipitates/aggregates are observed after 5 minutes, and precipitates/aggregates are observed after 24 hours.

C: Precipitates/aggregates are observed after 5 minutes.

### Formation of Printed Matter

On a 100%-cotton cloth, the treatment liquid composition was uniformly applied by a roller so as to have an amount of 6 to 8 g per an A4 size. After the application, a heat treatment was performed at 160° C. for 2.5 minutes in an oven. Subsequently, by an ink jet method using an ink jet printer (“PX-G930” manufactured by Seiko Epson Corporation), the ink composition was adhered to the cloth. As recording conditions, a recording resolution, an ink mass, and a recording range were set to 1,440 dpi×720 dpi, 23 ng/dot, and an A4 size, respectively, and a printed matter in which a solid pattern image was formed on the cloth used as a recording medium (ink was printed) was formed. The printed matter thus formed was dried by a heat treatment at 160° C. for 8 minutes.

In this case, the “solid pattern image” indicates an image in which dots are recorded in all pixels each of which is a minimum recording unit region defined by a recording resolution.

### Rubbing Fastness

A wet rubbing fastness of the printed matter was tested by a test method in accordance with ISO105-X12, and the rubbing fastness was evaluated by the following evaluation criteria.

### Evaluation Criteria

A: Class 2-3 or more

B: Class 2 to less than class 2-3

C: Class 1-2 or less

### Washing Resistance

After the printed matter was washed 5 times by a washing machine and then spontaneously dried, an OD value was measured using a fluorescent spectrum densitometer (“FD-7”, manufactured by Konica Minolta, Inc.), the difference in OD value of the cloth before and after the washing was calculated, and by the following evaluation criteria, the washing resistance was evaluated.

### Evaluation Criteria

A: ΔOD of less than 0.03

B: ΔOD of 0.03 to less than 0.06

C: ΔOD of 0.06 or more

### Color Development

After an OD value of the printed matter was measured using a fluorescent spectrum densitometer (“FD-7”, manufactured by Konica Minolta, Inc.), by the following evaluation criteria, the color development was evaluated.

### Evaluation Criteria

A: OD value of 1.35 or more

B: OD value of 1.30 to less than 1.35

C: OD value of less than 1.30

### Texture

After a shear hardness (gf/cm·degree) of the printed matter was tested using a tensile shearing tester (“KES-FB1-A”, manufactured by Kato Tech Co., Ltd.), the texture was evaluated by the following evaluation criteria.

### Evaluation Criteria

A: shear hardness of less than 7

B: shear hardness of 7 to less than 9

C: shear hardness of 9 to less than 11

D: shear hardness of 11 or more

TABLE 3

| | EXAMPLE 1 | EXAMPLE 2 | EXAMPLE 3 | EXAMPLE 4 | EXAMPLE 5 | EXAMPLE 6 |
|---|---|---|---|---|---|---|
| | TREATMENT | TREATMENT | TREATMENT | TREATMENT | TREATMENT | TREATMENT |
| | LIQUID | LIQUID | LIQUID | LIQUID | LIQUID | LIQUID |
| | COMPOSITION 1 | COMPOSITION 2 | COMPOSITION 3 | COMPOSITION 4 | COMPOSITION 5 | COMPOSITION 6 |
| STORAGE | A | B | A | A | A | A |
| STABILITY | | | | | | |
| RUBBING | A | A | B | A | A | A |
| FASTNESS | | | | | | |
| WASHING | A | A | B | A | A | A |
| RESISTANCE | | | | | | |
| COLOR | A | A | A | B | A | A |
| DEVELOPMENT | | | | | | |
| TEXTURE | B | B | A | C | A | B |
| | | | | COMPARATIVE | COMPARATIVE | COMPARATIVE |
| | EXAMPLE 7 | EXAMPLE 8 | EXAMPLE 9 | EXAMPLE 1 | EXAMPLE 2 | EXAMPLE 3 |
| | TREATMENT | TREATMENT | TREATMENT | TREATMENT | TREATMENT | TREATMENT |
| | LIQUID | LIQUID | LIQUID | LIQUID | LIQUID | LIQUID |
| | COMPOSITION 7 | COMPOSITION 8 | COMPOSITION 9 | COMPOSITION 10 | COMPOSITION 11 | COMPOSITION 12 |
| STORAGE | A | A | A | A | A | A |
| STABILITY | | | | | | |
| RUBBING | A | B | B | C | B | C |
| FASTNESS | | | | | | |
| WASHING | A | B | B | C | C | C |
| RESISTANCE | | | | | | |
| COLOR | A | A | A | A | A | A |
| DEVELOPMENT | | | | | | |
| TEXTURE | — | — | — | — | — | — |

### Evaluation Results

As for the rubbing fastness and the washing resistance of the printed matter of each example formed using the treatment liquid composition of this embodiment, the evaluation results are “B” or more, that is, are ranked as “B” or “A”, and accordingly, it is understood that the rubbing fastness and the washing resistance are both excellent.

From the comparison between Examples 1 and 2, it is found that when the polyester-based resin has no aggregating property to the cationic compound, the storage stability is more superior.

From the comparison between Example 1 and Example 5, it is found that when the specific surfactant is used, the texture is more superior.

From the comparison of Examples 1 and 7 with Examples 8 and 9, it is found that when the cationic polymer is used, the rubbing fastness and the washing resistance are more superior.

What is claimed is:

1. A treatment liquid composition for ink jet pigment printing to be adhered to a cloth, the treatment liquid composition comprising:
resin particles containing a polyester-based resin; and
a cationic compound.

2. The treatment liquid composition for ink jet pigment printing according to claim 1,
wherein the cloth contains hydrophobic fibers.

3. The treatment liquid composition for ink jet pigment printing according to claim 1,
wherein the polyester-based resin has no aggregating property to the cationic compound.

4. The treatment liquid composition for ink jet pigment printing according to claim 1,
wherein the polyester-based resin has a glass transition temperature of 20° C. or more.

5. The treatment liquid composition for ink jet pigment printing according to claim 1,
wherein the polyester-based resin has a weight average molecular weight of 10,000 to 200,000.

6. The treatment liquid composition for ink jet pigment printing according to claim 1,
wherein the cationic compound includes a cationic polymer.

7. The treatment liquid composition for ink jet pigment printing according to claim 1,
further comprising a surfactant,
wherein the surfactant includes an acetylene glycol-based surfactant having an HLB value of 10 or more.

8. The treatment liquid composition for ink jet pigment printing according to claim 7,
wherein the surfactant has a surface tension of 40 mN/m or more in an aqueous solution at a concentration of 0.1 percent by mass.

9. An ink set comprising:
the treatment liquid composition for ink jet pigment printing according to claim 1; and
an ink composition containing a pigment.

10. A recording method comprising:
adhering to a cloth, the treatment liquid composition for ink jet pigment printing according to claim 1.
